(19) United States
(12) Patent Application Publication
(10) Pub. No.: US 2015/0251776 A1
(43) Pub. Date: Sep. 10, 2015

(54) ENGINE INSTALLATION APPARATUS

(71) Applicant: IntelliPort Corporation (a Washington Corporation), Mount Vernon, WA (US)

(72) Inventor: Mel Terry, Mount Vernon, WA (US)

(73) Assignee: IntelliPort Corporation, Mount Vernon, WA (US)

(21) Appl. No.: 14/638,747

(22) Filed: Mar. 4, 2015

Related U.S. Application Data
(60) Provisional application No. 61/948,260, filed on Mar. 5, 2014.

(51) Int. Cl. B64F 5/00; F01D 25/28

(52) U.S. Cl. CPC B64F 5/0009; F01D 25/285

(57) ABSTRACT

An engine assembly and installation system includes an engine assembly stand having a base, a hydraulic cylinder formed within the base, a servo motor formed at one end of the hydraulic cylinder, and an engine support arm, one end of the engine support arm being connected to the servo motor, and an other end of the support arm being configured to support an engine; and an engine installation apparatus having a motor driven wheeled platform, a cantilevered engagement arm, and a battery/counterweight compartment, the cantilevered engagement arm including a plurality of servo motor driven gear heads. The engine installation apparatus is configured to remove an engine from the engine assembly stand.

### CROSS-REFERENCE TO RELATED APPLICATIONS

The is application claims priority to U.S. Provisional Application No. 61/948,260, filed on Mar. 5, 2014, the disclosure of which is incorporated herein by reference.

### BACKGROUND OF THE INVENTION

1. Field of the Invention

The present disclosure relates to an engine assembly stand and an engine installation apparatus, and particularly to an apparatus for precisely installing an aircraft engine.

2. Description of the Related Art

To install the engine of an aircraft, or remove the engine of an aircraft for inspection or repairs, a cradle mounted upon a frame assembly may be utilized, where the frame assembly includes lifting mechanisms to raise or lower the cradle may be utilized. However, this type of assembly has drawbacks in that precise alignment of the engine to the aircraft may be difficult and also slow production efficiency.

### SUMMARY

In accordance with one aspect, an engine assembly stand is provided including a base; a hydraulic cylinder formed within the base; a servo motor formed at one end of the hydraulic cylinder; and an engine support arm, one end of the engine support arm being connected to the servo motor, and an other end of the support arm being configured to support an engine.

In accordance with another aspect an engine installation apparatus is provided including a motor driven wheeled platform; a cantilevered engagement arm; and a battery/counterweight compartment, wherein the cantilevered engagement arm includes a plurality of servo motor driven gear heads.

In accordance with yet another aspect, an engine assembly and installation system is provided including an engine assembly stand having a base, a hydraulic cylinder formed within the base, a servo motor formed at one end of the hydraulic cylinder, and an engine support arm, one end of the engine support arm being connected to the servo motor, and an other end of the support arm being configured to support an engine; and an engine installation apparatus having a motor driven wheeled platform, a cantilevered engagement arm, and a battery/counterweight compartment, the cantilevered engagement arm including a plurality of servo motor driven gear heads, wherein the engine installation apparatus is configured to remove an engine from the engine assembly stand.

Additional aspects and/or advantages of the disclosure will be set forth in part in the description which follows and, in part, will be apparent from the description, or may be learned by practice of the disclosure.

### BRIEF DESCRIPTION OF THE DRAWINGS

These and/or other aspects and advantages of the disclosure will become apparent and more readily appreciated from the following description of the embodiments, taken in conjunction with the accompanying drawings of which:

FIGS. 1-6 are top and side views of an engine assembly stand according to an embodiment of the present disclosure;

FIG. 7 is a side view of an engine assembly stand operating in conjunction with an engine installation apparatus according to an embodiment of the present disclosure; and

FIGS. 8-10 are top and side views of an engine installation apparatus according to an embodiment of the present disclosure.

### DETAILED DESCRIPTION

Reference will now be made in detail to the embodiments of the present disclosure, examples of which are illustrated in the accompanying drawings, wherein like reference numerals refer to the like elements throughout. The embodiments are described below to explain the present disclosure by referring to the figures.

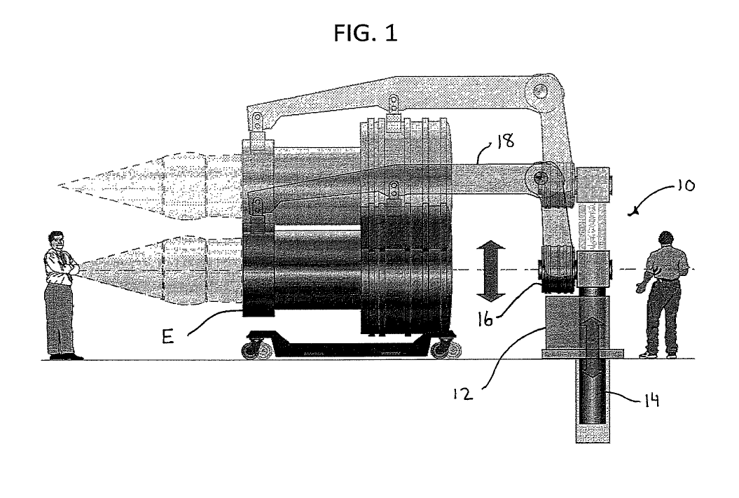

FIG. 1 shows an engine assembly stand 10 including a base 12, a hydraulic cylinder 14, a servo motor 16 and an engine support arm 18 to support the engine E. In FIG. 1, the engine assembly stand 10 is shown lifting the engine clear of the shipping skid SS.

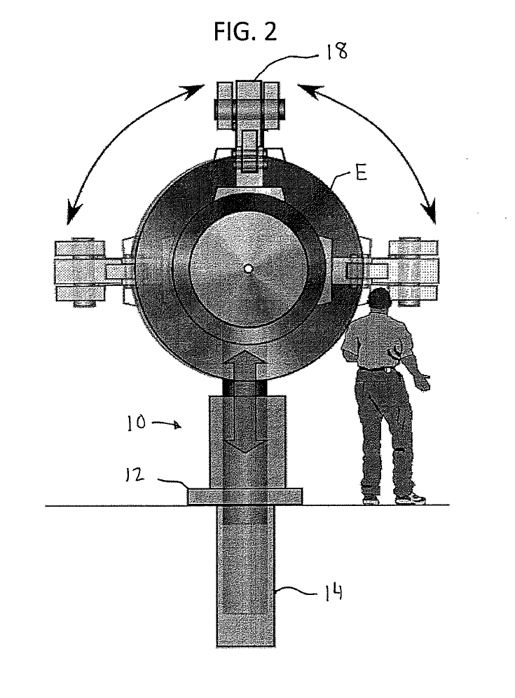

FIG. 2 shows the engine assembly stand 10 can rotate the engine E up to 90 degrees to the right or left using the servo motor 16, as well as raise and lower the engine E through the hydraulic cylinder 14 to make all assembly operations at the workers easiest height for faster and more ergonomic ease of assembly.

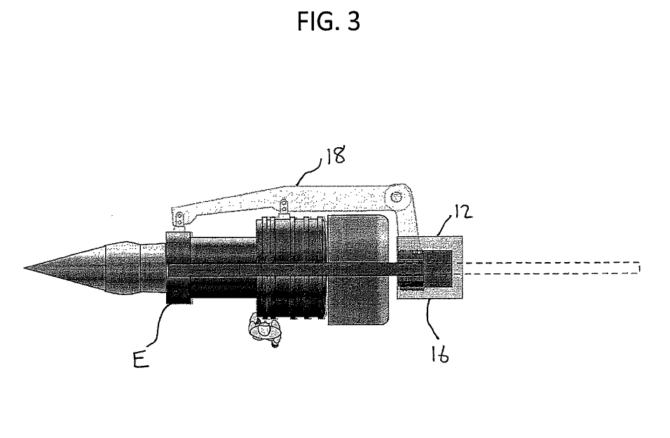

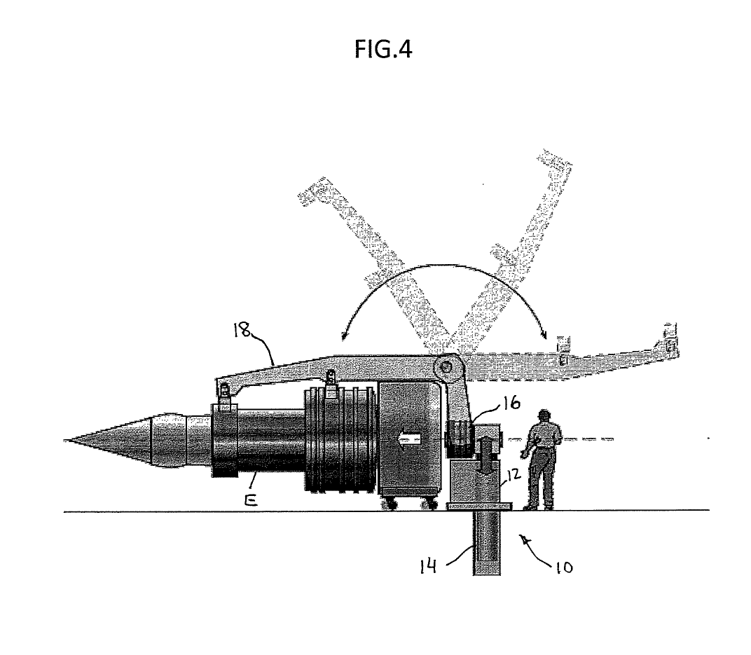

FIG. 3 shows a top view of the engine assembly stand 10. FIG. 4 shows a side view of engine assembly stand 10 where the support arm 18 of the engine assembly stand 10 can power rotate from a stowed position on the right to the position for lifting the engine from the shipping skids SS. The cowling that marries to the front of the engine is rolled into place on a castered cart.

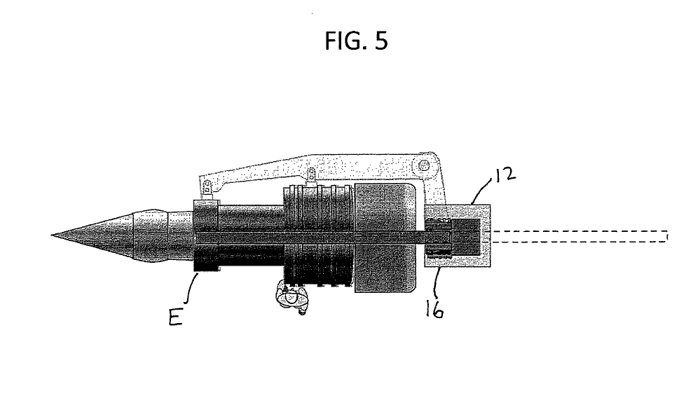

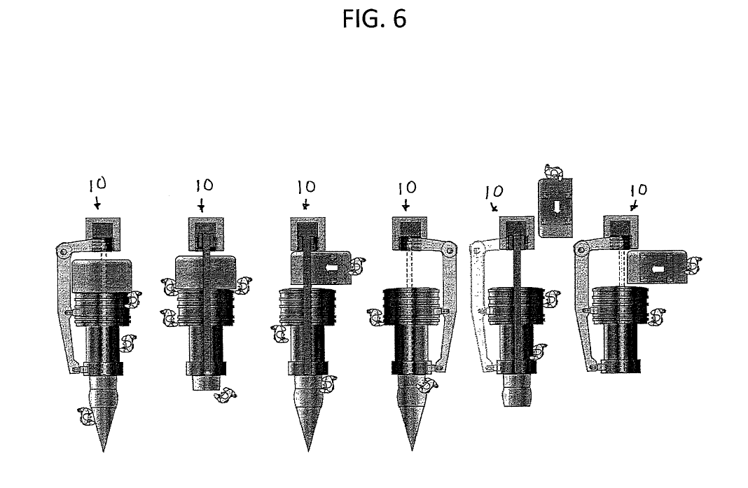

FIG. 5 shows another top view showing the engine on-center rotated 90 degrees to one side to allow work to be done on the bottom of the engine E, that is normally done from floor creepers. FIG. 6 shows engine assembly stand 10 in various attitudes that ease assembly of the engine E.

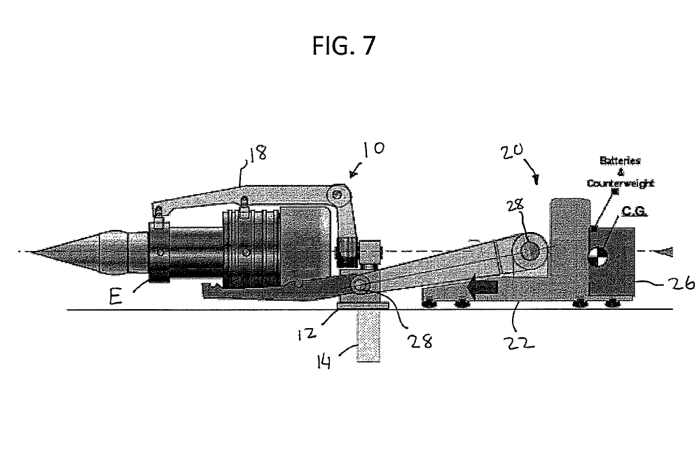

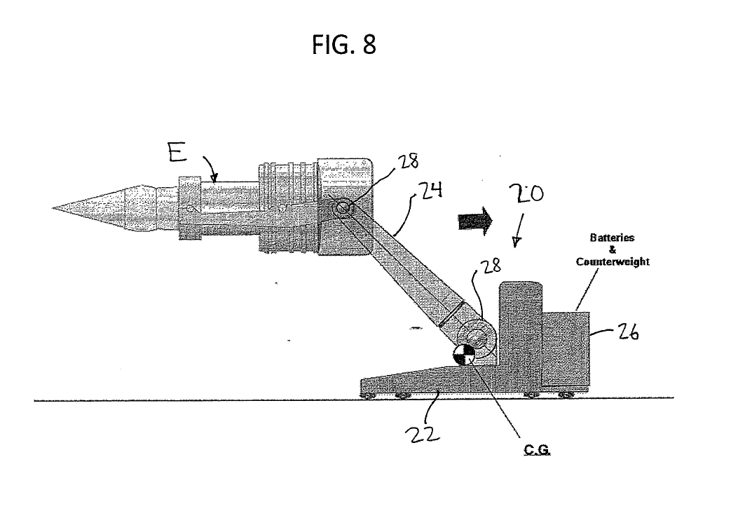

FIG. 7 shows an engine installation apparatus 20 including a motor driven wheeled platform 22, a cantilevered engagement arm 24 and a battery/counterweight compartment 26. The engine installation apparatus 20 may be operated in conjunction with the engine assembly stand 10. As shown in FIG. 7, to clear the larger diameter of the engine shroud of the engine E, the engine installation apparatus 20 lowers the engagement arm 24 near the floor and drives forward to align with the side lift points on the engine E, so that the engine E may be lifted by the engagement arm 24, as shown in FIG. 8.

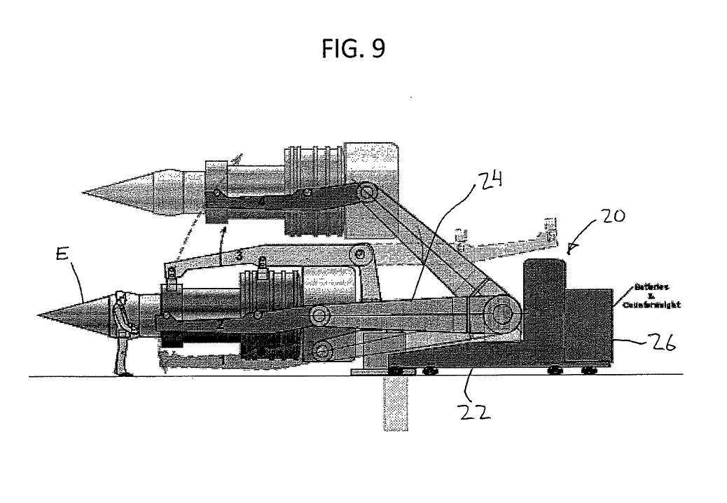

As shown in FIG. 9, the cantilevered engagement arm 24 includes a plurality of servo motor driven gear heads 28 at each of the rotation points of the cantilevered engagement arm 24 that emulate the control of one's wrist.

As shown in FIG. 9, as the forward part of the cantilevered engagement arm 24 engages the lift points on the side of the engine E and take the weight of the engine E, the lift attachments on the top of the engine E are released and the cantilevered engagement arm 24 of the engine installation apparatus 20 begins to rotate 180 degrees to provide a clear path for the user to lift the engine up over the engine installation apparatus 20.

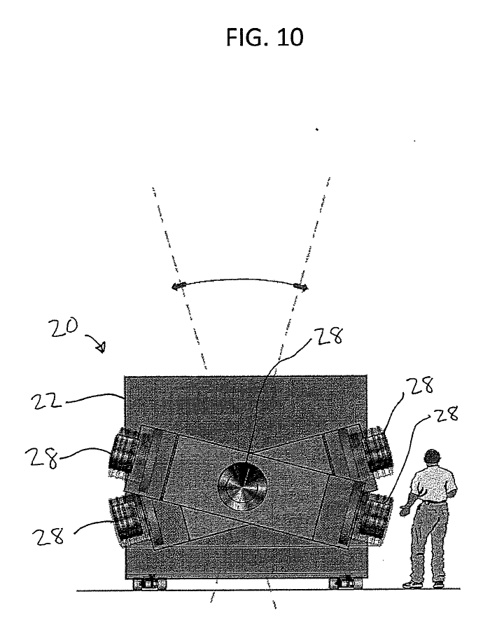

As shown in FIG. 10, due to the plurality of servo motor driven gear heads 28, the engine E can be precision rotated to the left or right to accommodate the angularity of the attachment into the engine pylons. The servo drive motors have the capability to provide travel speeds as low as 0.020 inches per minute in any direction and allow virtually infinite control when mating delicate components.

Although a few embodiments of the present disclosure have been shown and described, it would be appreciated by those skilled in the art that changes may be made in these embodiments without departing from the principles and spirit of the disclosure, the scope of which is defined in the claims and their equivalents.

What is claimed is:

1. An engine assembly stand, comprising:
a base;
a hydraulic cylinder formed within the base;
a servo motor formed at one end of the hydraulic cylinder; and
an engine support arm, one end of the engine support arm being connected to the servo motor, and an other end of the support arm being configured to support an engine.

2. An engine installation apparatus comprising:
a motor driven wheeled platform;
a cantilevered engagement arm; and
a battery/counterweight compartment,
wherein the cantilevered engagement arm includes a plurality of servo motor driven gear heads.

3. An engine assembly and installation system, comprising:
an engine assembly stand having a base, a hydraulic cylinder formed within the base, a servo motor formed at one end of the hydraulic cylinder, and an engine support arm, one end of the engine support arm being connected to the servo motor, and an other end of the support arm being configured to support an engine; and
an engine installation apparatus having a motor driven wheeled platform, a cantilevered engagement arm, and a battery/counterweight compartment, the cantilevered engagement arm including a plurality of servo motor driven gear heads,
wherein the engine installation apparatus is configured to remove an engine from the engine assembly stand.
